(19) United States
(12) Patent Application Publication
(10) Pub. No.: US 2024/0087031 A1
(43) Pub. Date: Mar. 14, 2024

(54) SYSTEM AND METHOD FOR GENERATING CUSTOM AGREEMENTS AND ONBOARDING PARTICIPANTS

(71) Applicant: Great Gray Trust Company, LLC, Las Vegas, NV (US)

(72) Inventors: Christopher Douglas RANDALL, Williamsville, NY (US); Robert Nelson BARNETT, III, Concord, MA (US)

(21) Appl. No.: 18/465,919

(22) Filed: Sep. 12, 2023

Related U.S. Application Data
(60) Provisional application No. 63/405,679, filed on Sep. 12, 2022.

(51) Int. Cl. G06Q 40/06

(52) U.S. Cl. CPC G06Q 40/06

(57) ABSTRACT

A computer-based method is provided for enrolling an eligible retirement plan or other eligible entity into a collective investment trust (CIT). The method includes receiving an electronic enrollment request for a plan, the enrollment request comprising enrollment data, wherein the enrollment data includes a plan identifier and an advisor identifier. An electronic eligibility request is transmitted to a DOL Form 5500 system, the electronic eligibility request including the plan identifier. The method includes receiving a response from the DOL Form 5500 system confirming a eligible status of the plan. An electronic list of available funds is retrieved based on the advisor identifier, and a selection of one or more funds is received. The method includes automatically generating a participation agreement for the plan and transmitting an electronic signature envelope to receive an electronically-signed copy of the participation agreement.

### CROSS-REFERENCE TO RELATED APPLICATIONS

This application claims priority to U.S. Provisional Application No. 63/405,679, filed on Sep. 12, 2022, now pending, the disclosure of which is incorporated herein by reference.

### FIELD OF THE DISCLOSURE

The presently disclosed embodiments are directed to providing a system and method for onboarding participants, more particularly for onboarding participants in a program/plan, and even more particularly for onboarding participants in a program/plan through a combination of processes including automated gathering of information from multiple sources and automated generation of a custom agreement.

### BACKGROUND OF THE DISCLOSURE

Collective investment trusts (CITs), also known as collective investment funds, collective trusts, etc., are groups of aggregated accounts held by a bank or trust company, collectively referred to as financial institutions herein. A financial institution amalgamates assets from various retirement plans, e.g., 401(k) plans and pension plans, to form a single larger portfolio.

CITs are not subject to Securities and Exchange Commission registration or the Investment Company Act of 1940. As such, financial institutions managing CITs are not required to issue prospectuses related to the CITs. To qualify for these exemptions, CITs must be maintained by a financial institution such a bank or a trust company, and investors must be limited to certain types of retirement plans. Due to a variety of factors, CITs have reduced cashflow volatility and lower costs. Because of the nature of CITs, such trusts are typically available to individuals only through employer sponsored retirement plans, pension plans, and insurance companies.

In order to participate in one or more CITs, a plan sponsor, e.g., an employer, or plan fiduciary, e.g., an investment manager, must enter into an agreement with a financial institution that offers CITs. The application process, including the volume and locations of necessary data, is complex and consumes multiple days to complete.

The present disclosure addresses systems and methods for onboarding participants in a program/plan through a combination of processes including automated gathering of information from multiple sources and automated generation of a custom agreement.

### BRIEF SUMMARY OF THE DISCLOSURE

Broadly, the systems and methods discussed infra provide for onboarding participants in a program/plan through a combination of processes including automated gathering of information from multiple sources and automated generation of a custom agreement.

Other objects, features and advantages of one or more embodiments will be readily appreciable from the following detailed description and from the accompanying drawings and claims.

### DESCRIPTION OF THE DRAWINGS

For a fuller understanding of the nature and objects of the disclosure, reference should be made to the following detailed description taken in conjunction with the accompanying drawings, in which:

FIG. 1 is a chart depicting a method according to an embodiment of the present disclosure;

FIG. 2 is an example interface of an embodiment of a present system comprising a computer based interface configured to perform the present method, the example interface providing a welcome screen;

FIG. 3 is an example interface of an embodiment of a present system comprising a computer based interface configured to perform the present method, the example interface providing a plan details screen of a new fund (enrollment) request;

FIG. 4 is an example interface of an embodiment of a present system comprising a computer based interface configured to perform the present method, the example interface providing a plan sponsor input of a new fund (enrollment) request;

FIG. 5 is an example interface of an embodiment of a present system comprising a computer based interface configured to perform the present method, the example interface providing a plan information and plan partners input of a new fund (enrollment) request;

FIG. 6 is an example interface of an embodiment of a present system comprising a computer based interface configured to perform the present method, the example interface providing the ability to edit plan data for a new fund (enrollment) request;

FIG. 7 is an example interface of an embodiment of a present system comprising a computer based interface configured to perform the present method, the example interface providing record keeper and trading platform search for a new fund (enrollment) request;

FIG. 8 is an example interface of an embodiment of a present system comprising a computer based interface configured to perform the present method, the example interface being similar to that of FIG. 7 and allowing for more detailed selection of share class(es) for a new fund (enrollment) request;

FIG. 9 is an example interface of an embodiment of a present system comprising a computer based interface configured to perform the present method, the example interface providing a plan details screen of a new fund (enrollment) request;

FIG. 10 is an example interface of an embodiment of a present system comprising a computer based interface configured to perform the present method, the example interface allowing for review and submission of the new fund (enrollment) request;

FIG. 11 is an example interface of an embodiment of a present system comprising a computer based interface configured to perform the present method, the example interface showing a submission in progress;

FIG. 12 is an example interface of an embodiment of a present system comprising a computer based interface configured to perform the present method, the example interface displaying confirmation of submission;

FIG. 13 is an example interface of an embodiment of a present system comprising a computer based interface configured to perform the present method, the example interface providing a dashboard of requests and including status information for each request;

FIG. 14 is an example interface of an embodiment of a present system comprising a computer based interface configured to perform the present method, the example interface providing detailed status information of a request;

FIG. 15 is an example interface of an embodiment of a present system comprising a computer based interface configured to perform the present method, the example interface showing an audit log (Activity Log) for a particular request;

FIG. 16 is an example interface of an embodiment of a present system comprising a computer based interface configured to perform the present method, the example interface showing the agreements associated with a particular request;

FIG. 17 is an example email including a customized agreement forwarded for electronic signature, wherein the customized agreement was produced by an embodiment of a present system;

FIG. 18 is a screen shot of a portion of the electronic signature process used in conjunction and/or as a part of an embodiment of a present system;

FIG. 19 is a screen shot of a portion of the electronic signature process used in conjunction and/or as a part of an embodiment of a present system;

FIG. 20 is a screen shot of a portion of the electronic signature process used in conjunction and/or as a part of an embodiment of a present system;

FIG. 21 is an example interface of an embodiment of a present system comprising a computer based interface configured to perform the present method;

FIG. 22 is an example interface of an embodiment of a present system comprising a computer based interface configured to perform the present method;

FIG. 23 is an example interface of an embodiment of a present system comprising a computer based interface configured to perform the present method;

FIG. 24 is an example interface of an embodiment of a present system comprising a computer based interface configured to perform the present method; and

FIG. 25 is a diagram of a system according to another embodiment of the present disclosure.

### DETAILED DESCRIPTION OF THE DISCLOSURE

At the outset, it should be understood that the embodiments shown and described herein are not limited to the particular methodology, materials, and modifications described and as such may, of course, vary. It is also understood that the terminology used herein is for the purpose of describing particular aspects only, and is not intended to limit the scope of the disclosed embodiments, which are limited only by the appended claims.

Unless defined otherwise, all technical and scientific terms used herein have the same meaning as commonly understood to one of ordinary skill in the art to which these embodiments belong. As used herein, “CUSIP” is intended to be broadly construed as any nine-digit numeric or nine-character alphanumeric code that identifies a North American financial security for the purposes of facilitating clearing and settlement of trades.

As used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. As used herein, the term ‘average’ shall be construed broadly to include any calculation in which a result datum or decision is obtained based on a plurality of input data, which can include but is not limited to, weighted averages, yes or no decisions based on rolling inputs, etc.

Moreover, although any methods, devices or materials similar or equivalent to those described herein can be used in the practice or testing of these embodiments, some embodiments of methods, devices, and materials are now described.

The present systems and methods are used by a variety of entities to facilitate onboarding participants in a program/plan. For example, in some embodiments, plan sponsors use the present systems and methods to create a plan, make changes to a plan, and enter into a formal written agreement thereby making the plan available to parties associated with the plan sponsor. As used herein, “plan sponsor” is intended to be broadly construed to include the plan sponsor and/or a fiduciary authorized to represent the plan. It should be appreciated that in order to be able to participate in a plan, a plan sponsor must first enter into a participation agreement. The present systems and methods are used to perfect such entry into an agreement.

In a first aspect, the present disclosure may be embodied as a computer-based method 100 for enrolling an eligible retirement plan or other eligible entity into a collective investment trust (CIT). The method 100 includes receiving 103 an electronic enrollment request for a plan. The term plan is used for convenience, and should be broadly construed herein to include any entity eligible for inclusion in a CIT. The enrollment request may be in the form of a posted web form, The enrollment request is made up of enrollment data. The enrollment data includes a plan identifier and an advisor identifier.

The enrollment data may further include plan sponsor data, record keeper contact data, transfer agent contact data, trading platform data.

The method 100 includes transmitting 106 an electronic eligibility request to a DOL Form 5500 system. The U.S. Department of Labor (DOL), Internal Revenue Service, and the Pension Benefit Guaranty Corporation jointly developed the Form 5500 Series forms with which employee benefit plans can satisfy annual reporting requirements under Title I and Title IV of ERISA and under the Internal Revenue Code. Information collected from the Form 5500 Series forms is recorded and made available via a DOL Form 5500 system. In some embodiments, the DOL Form 5500 system is a database created and updated by importing Form 5500 data from the DOL. In some embodiments, the DOL Form 5500 system is an independent system accessible on a local network or by way of the internet. The transmitted 106 electronic eligibility request includes the plan identifier received on the enrollment request.

A response is received 109 from the DOL Form 5500 system confirming a eligible status of the plan. Additional data may be received in the response. For example, plan sponsor data (e.g., plan sponsor name, plan sponsor address, plan sponsor telephone number, plan sponsor tax ID, plan sponsor lead contact name, plan sponsor lead contact address, plan sponsor lead contact phone number, plan sponsor lead contact email address, etc.). In some embodiments, some or all of such additional data may have been received 103 as part of the enrollment data of the enrollment request. As such, the DOL Form 5500 additional data may be compared with the enrollment data (and an exception process—e.g., email notification, report generation, etc.—may be followed where some or all data does not match).

The method 100 includes, retrieving 112, from a funds database, an electronic list of available funds based on the advisor identifier. The retrieved list of available funds is displaying 115, on a user interface, as a selection list. By displaying on a user interface, any of a variety of techniques may be used. For example, code for a web page (e.g., html, javascript, and/or other tools and languages) can be generated, and such code may be transmitted to a display of a user's computer. Other techniques can be used (e.g., mobile displays, local displays, etc.) and are within the scope of the present disclosure. When enrolling a plan, a plan sponsor must select one or more funds to make available to participants in the plan. Some embodiments of the present system and method present the list of available funds in selectable form, e.g., a selection box associated with each fund, so that plan sponsors may select any combination of the available funds when establishing the plan. Moreover, in some embodiments, selected funds may be presented for a particular plan, based on the plan advisor associated with a particular plan.

A selection of one or more funds from the list of available funds is made by the plan sponsor (i.e., via the plan sponsor lead contact, the plan advisor, or other representative), and the selection is received 118.

The method 100 includes determining 121 if a participation agreement can be generated or if additional data is needed. The determination 121 is based on the enrollment data needed to automatically generate a participation agreement. If the enrollment data is not complete (i.e., the enrollment data is insufficient to generate a participation agreement), the method may further include steps to remedy the incomplete data. For example, the method may include sending email or other reminders to users requesting additional data, updating an enrollment status field to indicate the incomplete status, creating a report indicating which data is missing, etc. The enrollment data necessary to complete a participation agreement may vary according to agreement format of the trustee performing the method. One having skill in the art will recognize what information is needed for a particular trustee.

Once sufficient data is present in the enrollment data, the method 100 includes generating 124, automatically, the participation agreement for the plan. The participation agreement will typically include a listing of the one or more funds selected and received 118 as above.

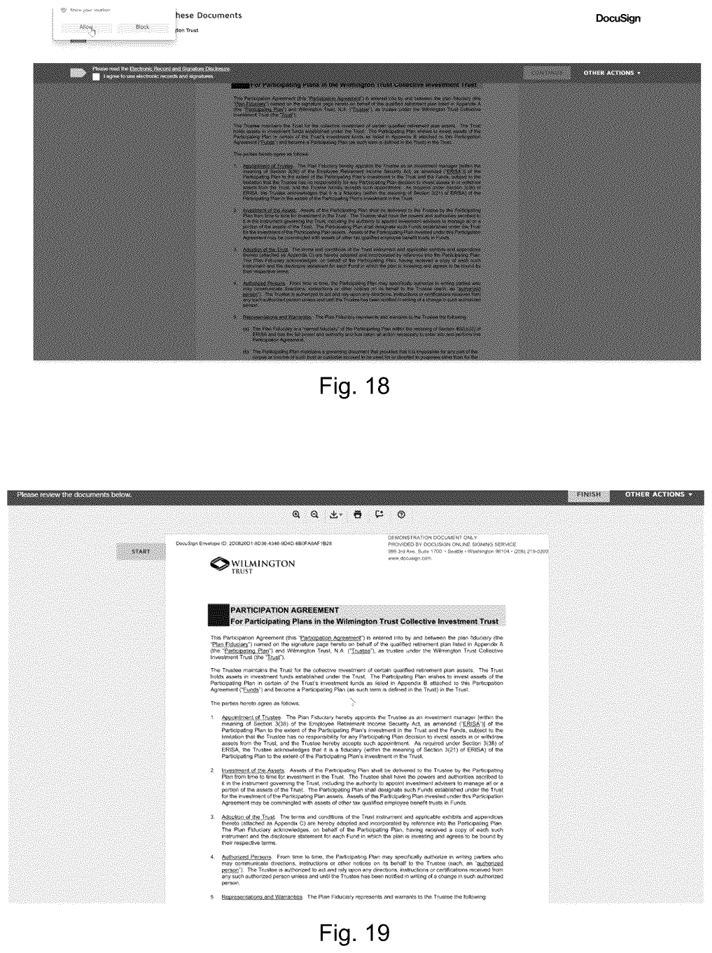

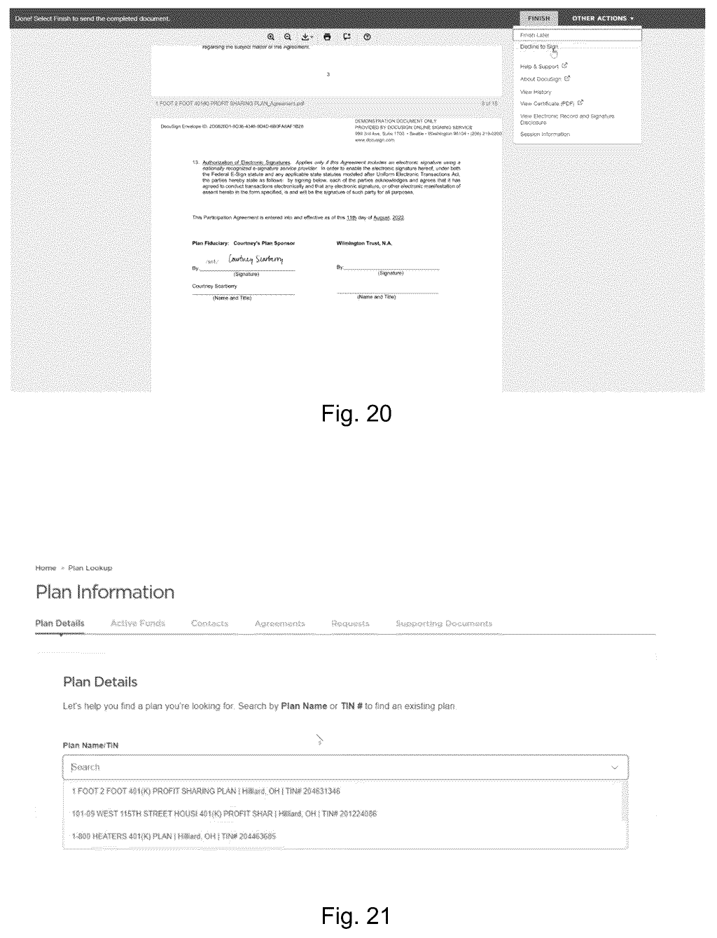

An electronic signature envelope is transmitted 127 to a signature provider. The electronic signature envelope includes the generated 124 participation agreement. The electronic signature envelope may also include or be transmitted with, a signatory name and email address. In this way, the signature provider will obtain an electronic signature (e.g., a trusted and verified signature) on the participation agreement. For example, DocuSign may be used as the signature provider, and the electronic signature envelope is transmitted to DocuSign. FIG. 17 shows an example email provided to a signatory by the signature provider (in this case, DocuSign). FIGS. 18-20 depict steps in DocuSign's signature process.

The electronically-signed participation agreement is received 130 from the signature provider. In some embodiments, a reminder may be transmitted 133 when a signed participation agreement has not been received within a predetermined period of time. The reminder may be sent to the identified signatory and/or other contact (plan sponsor, plan advisor, etc.)

The plan is then identified 136 as “ready to trade.” Identifying 136 may take various forms. For example, in some embodiments, the plan record in a trustee database may be flagged as ready to trade. In some embodiments, the plan enrollment data may be added to a database or other data store of the trustee, indicating that the plan has been enrolled (i.e., ready to trade). Notifications may be transmitted to other parties as to the “ready to trade” status. For example, a notification may be sent to the plan advisor, the record keeper, the trading platform, and/or the transfer agent. Other notifications may be sent indicating the enrolled (ready to trade) status of the plan as may be appropriate and will be apparent to those skilled in the art.

Other actions may be appropriate before the plan is identified as enrolled. For example, a signature (e.g., an electronic signature) may be obtained by the counterparty of the participation agreement (e.g., the trustee of the CIT).

In another aspect, the present disclosure may be embodied as a system 10 for enrolling an eligible retirement plan or other eligible entity into a CIT. The system 10 includes a processor 12 and a storage medium 14 (e.g., disk drive, solid state drive, or any type of non-transitory storage device) in electronic communication with the processor 12. The system 10 may also have a communication port 16 in electronic communication with the processor 20. The communication port 16 may provide access to a network 30, such as, for example, the internet. The processor 20 may be programmed to perform any of the methods disclosed herein. For example, the processor 20 may be programmed to receive an electronic enrollment request for a plan, the enrollment request comprising enrollment data, wherein the enrollment data includes a plan identifier and an advisor identifier; transmit an electronic eligibility request to a DOL Form 5500 system, the electronic eligibility request including the plan identifier; receive a response from the DOL Form 5500 system confirming a eligible status of the plan; retrieve, from a funds database, an electronic list of available funds based on the advisor identifier and displaying, on a user interface, the list of available funds as a selection list; receive a selection of one or more funds from the list of available funds; determine if a participation agreement can be generated or if additional data is needed; generate, automatically, the participation agreement for the plan based on the enrollment data and including the selection of one or more funds; transmit, an electronic signature envelope to a signature provider, the electronic signature envelope comprising the participation agreement; receive an electronically-signed participation agreement from the signature provider; and identify the plan as ready to trade.

The DOL Form 5500 system may be an independent computer 90. For example, the DOL Form 5500 system may be accessible by way of the communication port 16. In some embodiments, the DOL Form 5500 system is stored locally. For example, the DOL Form 5500 system may be a database 20 stored on the storage medium 14.

In some embodiments, the processor determines if a participation agreement can be generated or if additional data is needed by confirming all of the necessary information is recorded (e.g., recorded in the enrollment request or in another location accessible to create the participation agreement). For example, the processor may be programmed to confirm record keeper contact data is recorded; confirm transfer agent contact data is recorded; confirm trading platform data is recorded; and confirm plan sponsor contact data is recorded. In some embodiments, such contact data may include name, address, email address, phone number, and/or other relevant contact data.

In some embodiments, an enrollment dashboard may be provided. The processor may be further programmed to update an enrollment status field; and generate an enrollment dashboard including the enrollment status field.

In some embodiments, the processor is further programmed to transmit a reminder to an enrollment contact if the electronically-signed participation agreement is not received within a predetermined period of time.

In some embodiments, the processor is further programmed to export transfer agent data from the enrollment data; and transmitting the transfer agent data to the transfer agent.

In another aspect, the present disclosure may be embodied as a non-transitory computer-readable medium having stored thereon a program for instructing a processor to perform any of the methods disclosed herein. For example, the non-transitory medium may have instructions for a processor to receive an electronic enrollment request for a plan, the enrollment request comprising enrollment data, wherein the enrollment data includes a plan identifier and an advisor identifier; transmit an electronic eligibility request to a DOL Form 5500 system, the electronic eligibility request including the plan identifier; receive a response from the DOL Form 5500 system confirming a eligible status of the plan; retrieve, from a funds database, an electronic list of available funds based on the advisor identifier and displaying, on a user interface, the list of available funds as a selection list; receive a selection of one or more funds from the list of available funds; determine if a participation agreement can be generated or if additional data is needed; generate, automatically, the participation agreement for the plan based on the enrollment data and including the selection of one or more funds; transmit, an electronic signature envelope to a signature provider, the electronic signature envelope comprising the participation agreement; receive an electronically-signed participation agreement from the signature provider; and identify the plan as ready to trade.

In some embodiments, the non-transitory medium may further include processor instructions to determine if a participation agreement can be generated or if additional data is needed by: confirming record keeper contact data is recorded; confirming transfer agent contact data is recorded; confirming trading platform data is recorded; and confirming plan sponsor contact data is recorded.

In some embodiments, the non-transitory medium may further include processor instructions to update an enrollment status field, and to generate an enrollment dashboard including the enrollment status field. In some embodiments, the non-transitory medium may further include processor instructions to transmit a reminder to an enrollment contact if the electronically-signed participation agreement is not received within a predetermined period of time. In some embodiments, the non-transitory medium may further include processor instructions to export transfer agent data from the enrollment data; and transmitting the transfer agent data to the transfer agent.

In some embodiments, the present system is connected to internal and/or external storage components, e.g., a database, a data file, a hard drive, physical memory, etc. Connections of various types may be used independently or in combination with each other. For example, connections may be created via wired/wireless Ethernet, via a motherboard, or any other means known in the art. The foregoing storage components may include a variety of data such as a pool of funds that may be included in a particular plan, data related to the plan itself including but not limited to tax identification, type, administrator, etc., data related to the entity under which the plan will be established, e.g., a business entity establishing a plan, or data related to various parties involved in the administration of a plan, e.g., record keepers, advisors, etc. Some embodiments of the present system are configured to pull data from publicly available databases, e.g., Department of Labor databases, and such data may be used in the preparation of a participation agreement, may be used to populate a database that is privately held to speed future use of such data, or may be used for both purposes.

Furthermore, data related to various funds may be amalgamated and stored locally thereby facilitating efficient, future use of such data. For example, some embodiments of the present system are configured to pull data from databases of advisors that offer various funds for inclusion in a plan. Any number of advisors may be incorporated in the fund offerings. In some embodiments described herein, the present system may pull such fund data from an advisor database as the funds are added to a plan, and store such data for future instances when that fund is selected. Such data may be stored locally rather than pulled each time a fund is selected. The foregoing arrangement improves the efficiency and speed at which the present system can populate a plan and generate a participation agreement. Alternatively, in some embodiments the present system scrapes advisor databases at the onset, as well as periodically for updates, to obtain data related to all funds offered by that advisor. The data can then be used each time a fund falling within that data is selected for inclusion in a plan. Sequestering data in this way permits a financial institution to utilize the data in future agreements as described above, or to monetize the data, e.g., through subscription access to the database. A licensed database containing fund, record keeper, advisor, etc. related data is more efficient to use than obtaining the same data from multiple sources.

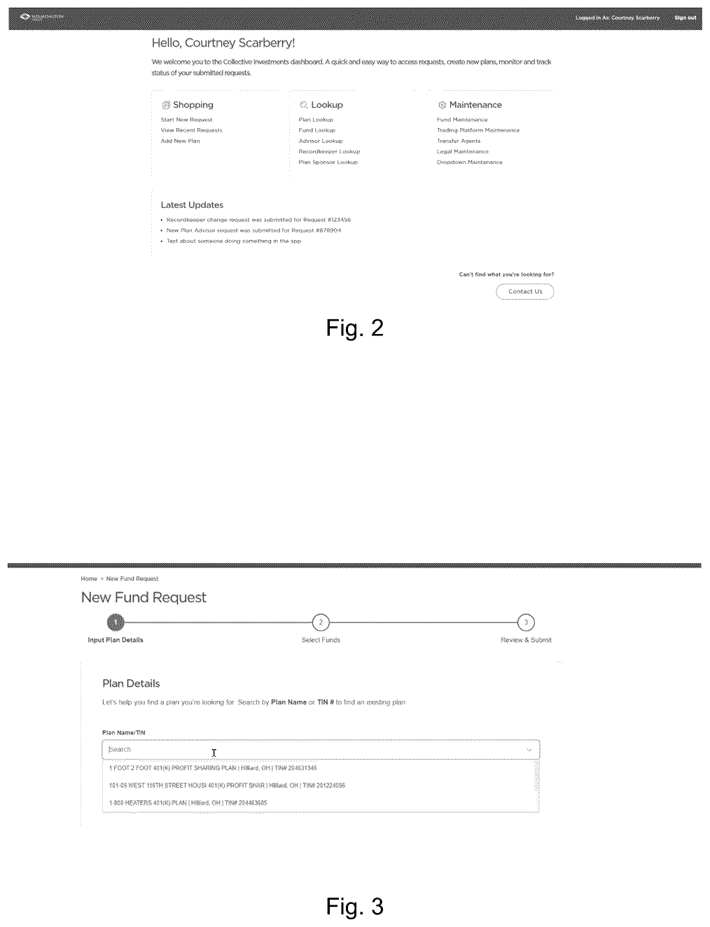

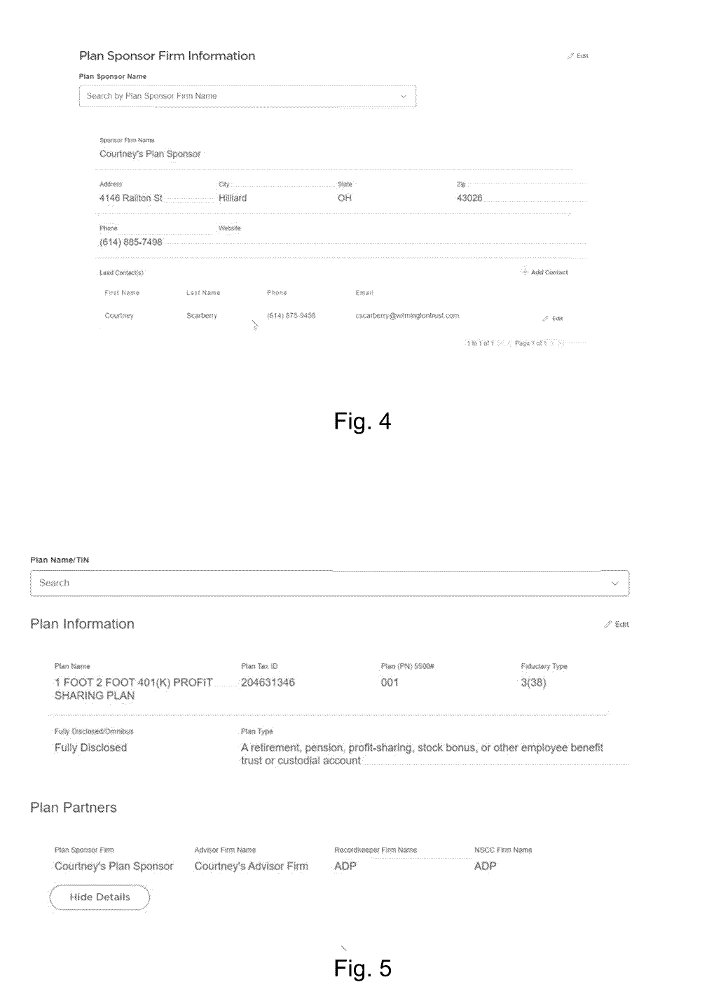

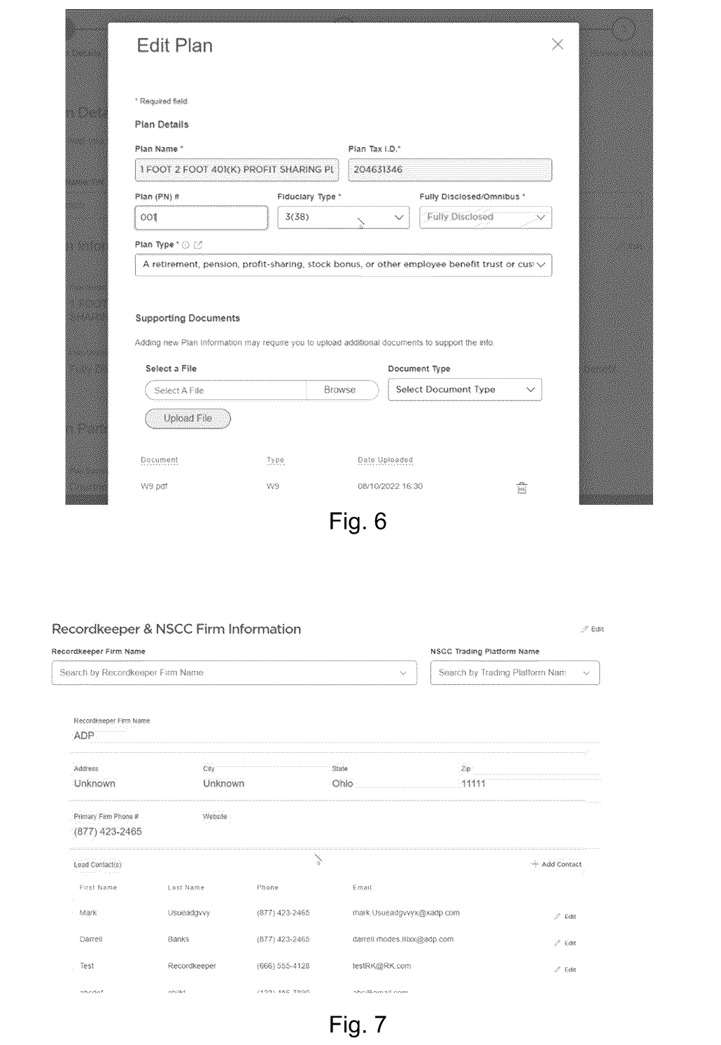

Data from both internal and external databases may be obtained and/or utilized by the present system at various steps within the process, i.e., all data does not have to be obtained simultaneously. For example, during the process of establishing the plan information, e.g., as shown in FIGS. 2 through 6, data may be obtained from the DOL5500 databases thereby automating the entry of data by the plan sponsor. As described above, the first instance of obtaining such data may require pulling data from external databases, however, all subsequent instances of obtaining that data can utilize data that is stored locally after the first instance.

As will be appreciated by those skilled in the art, the process of enrolling a plan, including creating an executable participation agreement, is complex and requires input from various parties involved in the process, e.g., plan sponsors, plan advisors, record keepers, sales contacts, etc. The logistics of tracking and acting upon the variety and magnitude of data, in part, adds complexity to the process of forming and offering a plan. The present system, in some embodiments, is configured to automate the gathering of data and approvals. For example, in Table 1 below, Stage 25 is Awaiting Customer Signature, and the present system may automatically generate and transmit a custom participation agreement to a plan sponsor or fiduciary for execution, and upon such execution, automatically forward the document to the financial institution for execution. Similarly, some embodiments of the present system are configured to send reminders to relevant parties when actions have not been completed. For example, if the agreement has been forwarded to a plan sponsor and it has not been executed, the present system can automatically send a reminder that an outstanding action is awaiting completion. Such automation, similar to other efficiencies provided by the system, significantly reduces the length of time to complete the process of creating and deploying a plan.

Moreover, the present system provides a common location to store information thereby permitting multiple parties, e.g., plan sponsor, record keeper, advisor, to simultaneously interact with the system, data and/or agreements. Due to various obligations, the integrity of the databases may need to be demonstrated. In view of the various parties having simultaneous access to databases, audit logs have been incorporated in some embodiments of the present system. Changes to data, enrollment of plans, as well as any other activity that may impact the accuracy or functionality of the present system can be captured via audit logs so that a party making a change is known.

Upon completion of entering plan details, whether from a user, automatically added from associated databases, or a combination thereof, a user, such as a plan sponsor, may submit the request. Upon submission, some embodiments of the present system examine the data and determine if an agreement can be generated or if additional data is needed. In some embodiments, the present system performs the quality checks associated with Stage 15 below. However, it should be appreciated that the quality checks set forth below are not intended to be limiting and that fewer or greater number of quality checks may be performed based on the needs of the particular embodiment of the present system. If the quality checks do not confirm that all data has been provided, the user is notified and additional data is requested. If the quality checks confirm that all data has been provided, the present system assembles a participation agreement, based on the provided data, and forwards the agreement for electronic signature. It should be appreciated that the foregoing automation is present in some embodiments, and may take a variety of forms. For example, as previously described, a custom agreement may be generated and automatically forwarded for electronic signature. In some embodiments, the present system generates the same agreement for each user, and in some embodiments the agreement is created and forwarded to the parties for traditional signatures, also referred to as wet signatures.

It should be appreciated that the arrangement of some embodiments of the present invention facilitate the automatic updating of contractual terms due to regulatory changes, changes in the law, changes in business practices, etc. In other terms, it has been found that the ability to assemble a custom agreement based on data provided by a user also permits updating the same agreements with new contractual terms. In the same way that a contract may be customized by including and excluding particular terms, for term updates, the present system can replace previous terms with new terms, or if needed, add/remove terms in accordance with the basis of the changes, e.g., regulatory direction.

Furthermore, although the data contained within the present system is most often used within the present system itself, the data may also be useful outside of the present system. Thus, data output can be configured for subsequent use. For example, a transfer agent may be engaged to maintain financial records related to a plan. Data received by the transfer agent must be entered into the transfer agent's systems. The data entry may be automated or manual. Manual entry is prone to errors, so automated entry is desirable. In some embodiments, the present system is configured to output data in a predefined structured form which facilitates the direct import of such data into a transfer agent's system, thereby reducing transcription errors. It should be appreciated that the present system may be configured to output the same format of data each time, e.g., comma separated values, or may be configured to output data in more complex forms, e.g., SQL, XML, etc.

The present methods comprise a variety of data collection, data retrieval, and data analysis activities that yield a collective repository of data that increases the performance capabilities of the present systems over time. An embodiment of the present method is broken into stages as set forth below in Table 1.

TABLE 1

| Stage | Request Detailed Status | Request Displayed Status |
|---|---|---|
| 0 | | Request Open |
| 5 | Request Open | Request Open |
| 10 | Ready To Shop | |
| 15 | Request Processing | Processing Information |
| 20 | Agreement(s) Being Created | Processing Information |
| 25 | Awaiting Customer Signature | Awaiting Signature |
| 30 | Awaiting FI Signature | Awaiting Signature |
| 35 | TA Info Check | Approved |
| 40 | Sending Info to TA | Approved |
| 45 | Awaiting Information from TA | Approved |
| 50 | Sending Ready to Trade Info | Approved |
| 55 | Ready to Trade | Ready to Trade |

Depending on the perspective of the person considering the stage, either the “Request Detailed Status” or the “Request Displayed Status” is made available. For example, if the party utilizing the present system is performing tasks on behalf of the financial institution, the Request Detailed Status field is presented. Thus, that party understands that a request has been opened, and is ready to shop, if the process is at Stage 10. Contrarily, if the party using the system is the plan fiduciary, the Request Displayed Status is presented. Thus, that party understands that a request has been opened, and is currently awaiting signature, if the process is at Stage 25 or 30.

At each step set forth in Table 1 above, the present method analyzes the data that has been provided or obtained, and determines if the method can proceed or if additional information/data is necessary. Table 2 below includes a variety of inquiries that can be used in various embodiments of the present method to analyze the data and facilitate the process of onboarding participants in one or more plans.

TABLE 2

| Request Info | |
|---|---|
| Check Stage | Request Info Check |
| 5 | Is there a Plan associated with the request? |
| 5 | Is there a Plan Sponsor associated with the request? |
| 5 | Is there a Plan Advisor associated with the request? |
| 5 | Is there a Record Keeper associated with the request |
| 5 | Is there a Trading Platform associated with the request? |
| 10 | Are there CUSIPS(s) associated with request? |
| 15 | Is the Plan name not null? |
| 15 | Does the Plan associated with the request |
| | have a Tax Id Number? |
| 15 | Does the Plan associated with the request |
| | have a plan Type selected? |
| 15 | Does the plan associated with the request |
| | have a Fiduciary Type |
| 15 | Does the Plan associated with the request have a PIN |
| 15 | Does the Plan associated with the request |
| | have either Omnibus/Fully Disclosed selected? |
| 15 | Does the Plan have an Associated Sales Contact |
| | associated with the Request? |
| 15 | Does the Plan have an Associated Sales Contact |
| | First Name Populated with the Request? |
| 15 | Does the Plan have an Associated Sales Contact |
| | Last Name Populated with the Request? |
| 15 | Does the Plan have an Associated Sales Contact |
| | Email address Populated with the Request? |
| 15 | Does the Plan have an Associated Sales Contact |
| | Phone Number Populated with the Request? |
| 15 | Does the Plan have an Associated RPAG Contact |
| | associated with the Request? |
| 15 | Does the Plan have an Associated RPAG Contact |
| | First Name Populated with the Request? |
| 15 | Does the Plan have an Associated RPAG Contact |
| | Last Name Populated with the Request? |
| 15 | Does the Plan have an Associated RPAG Contact |
| | Email address Populated with the Request? |
| 15 | Does the Plan have an Associated RPAG Contact |
| | Phone Number Populated with the Request? |
| 15 | Does the Plan associated with the request have |
| | the Start Up Plan flag populated? |
| 15 | Does the Plan associated with the request have |
| | the Government Entity Flag populated? |
| 15 | Does the Plan Sponsor associated with the Plan |
| | have a firm name? |
| 15 | Does the Plan Sponsor associated with the plan |
| | have a lead contact First Name |
| 15 | Does the Plan Sponsor associated with the plan |
| | have a lead contact Last Name |
| 15 | Does the Plan Sponsor associated with the plan |
| | have a lead contact Phone |
| 15 | Does the Plan Sponsor associated with the plan |
| | have a lead contact Email address |
| 15 | Does the Plan Sponsor Address match the Plan |
| | Address from the 5500? |
| 15 | Does the Plan Advisor associated with the Plan |
| | have a firm name? |
| 15 | Does the Plan Advisor associated with the plan |
| | have a lead contact First Name |
| 15 | Does the Plan Advisor associated with the plan |
| | have a lead contact Last Name |
| 15 | Does the Plan Advisor associated with the plan |
| | have a lead contact Phone |
| 15 | Does the Plan Advisor associated with the plan |
| | have a lead contact Email address |
| 15 | Does the Record Keeper associated with the Plan |
| | have a firm name? |
| 15 | Does the Record Keeper associated with the plan |
| | have a lead contact First Name |
| 15 | Does the Record Keeper associated with the plan |
| | have a lead contact Last Name |
| 15 | Does the Record Keeper associated with the plan |
| | have a lead contact Phone |
| 15 | Does the Record Keeper associated with the plan |
| | have a lead contact Email address |
| 15 | Does the Trading Platform associated with the |
| | Plan have a firm name? |
| 15 | Does the Trading Platform associated with the |
| | plan have a NSCC Number? |
| 15 | Does the Trading Platform associated with the |
| | plan have a lead contact First Name |
| 15 | Does the Trading Platform associated with the plan |
| | have a lead contact Last Name |
| 15 | Does the Trading Platform associated with the plan |
| | have a lead contact Phone |
| 15 | Does the Trading Platform associated with the plan |
| | have a lead contact Email address |
| 15 | Does the Fund(s) on the request require additional |
| | information (flag set on CUSIP record) |
| 15 | If the fund has CUSIP that require additional information |
| | is the Initial Funding Amount Populated? |
| 15 | If the fund has CUSIP that require additional information |
| | is the Initial Funding Date Populated? |
| 15 | If the fund has CUSIP that require additional information |
| | is the Initial coming from Mutual Fund Flag Populated? |
| 15 | Are there any CUSIPs that require special Exhibits? |
| 20 | Have Agreement(s) for the Fund Been created? |
| 20 | Does agreement(s) need special information attached? |
| 25 | Have the Agreement(s) been signed by Sponsor/Agent? |
| 30 | |
| 35 | Does the request have a Transfer Agent Assigned? |
| 35 | Does the transfer agent assigned to the plan |
| | have a lead contact first name? |
| 35 | Does the transfer agent assigned to the plan |
| | have a lead contact Last name? |
| 35 | Does the transfer agent assigned to the plan |
| | have a lead contact Email address? |
| 35 | Does the transfer agent assigned to the plan |
| | have a lead contact File transfer instruction? |
| 35 | Does the transfer agent assigned to the plan |
| | have a lead contact Phone Number? |
| 40 | Has the Plan information been successfully sent |
| | to the Transfer Agent with Acknowledgement? |
| 40 | Has the Transfer Agent returned the Plan Id Number? |
| 40 | Has the Transfer Agent Returned the Share Id Number |
| | for the Plan per the request |
| 45 | Did the Transfer Agent Information get populated |
| | in the Plan information and request record? |
| 50 | Did the Ready to trade notification go to |
| | the Plan sponsor lead contact(s)? |
| 50 | Did the Ready to trade notification go to |
| | the Plan Advisor lead contact(s)? |
| 50 | Did the Ready to trade notification go to |
| | the Record Keeper Lead contact(s)? |
| 50 | Did the Ready to trade notification go to |
| | the Trading Platform Lead Contacts? |
| 50 | Did the Ready to trade notification go to |
| | the Associated Sales Contact? |
| 50 | Did the Ready to trade notification go to |
| | the Associated Operations Main Mailbox |
| 50 | Did the Ready to trade notification |
| | go to the RPAG Contact? |
| | Did the Ready to trade notification |
| | go to the Transfer Agent |

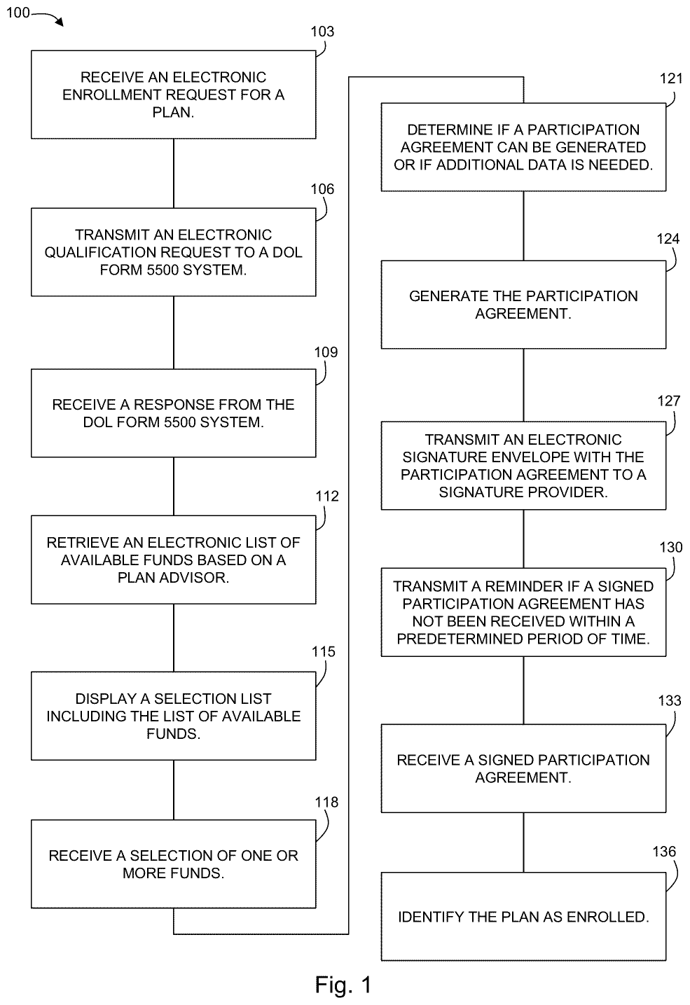

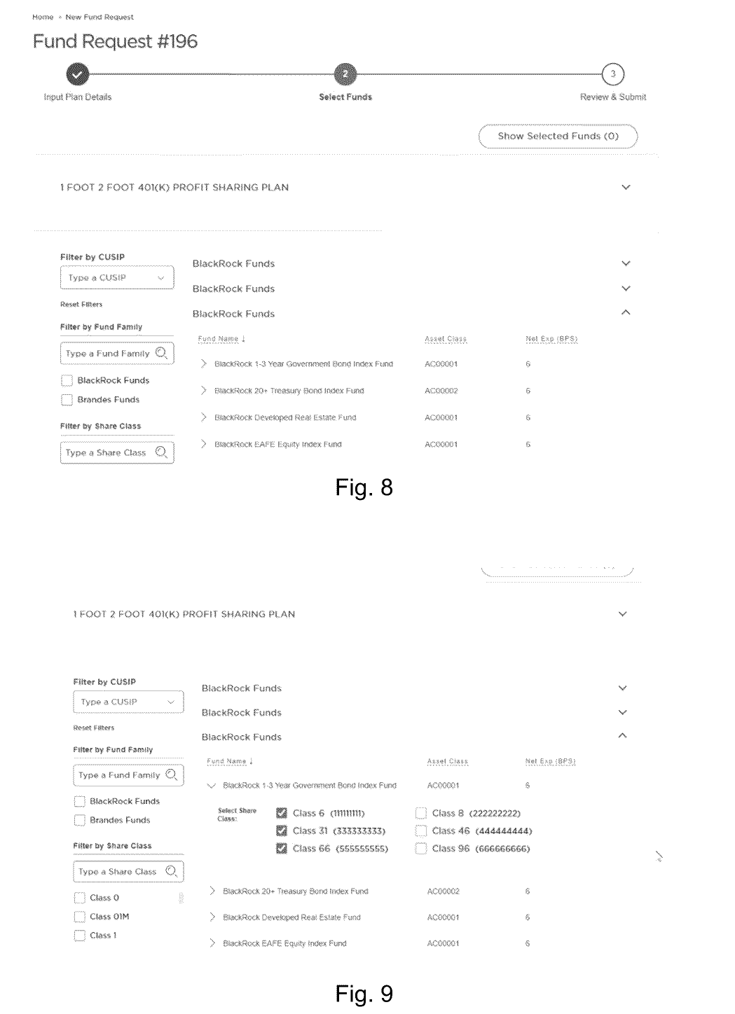

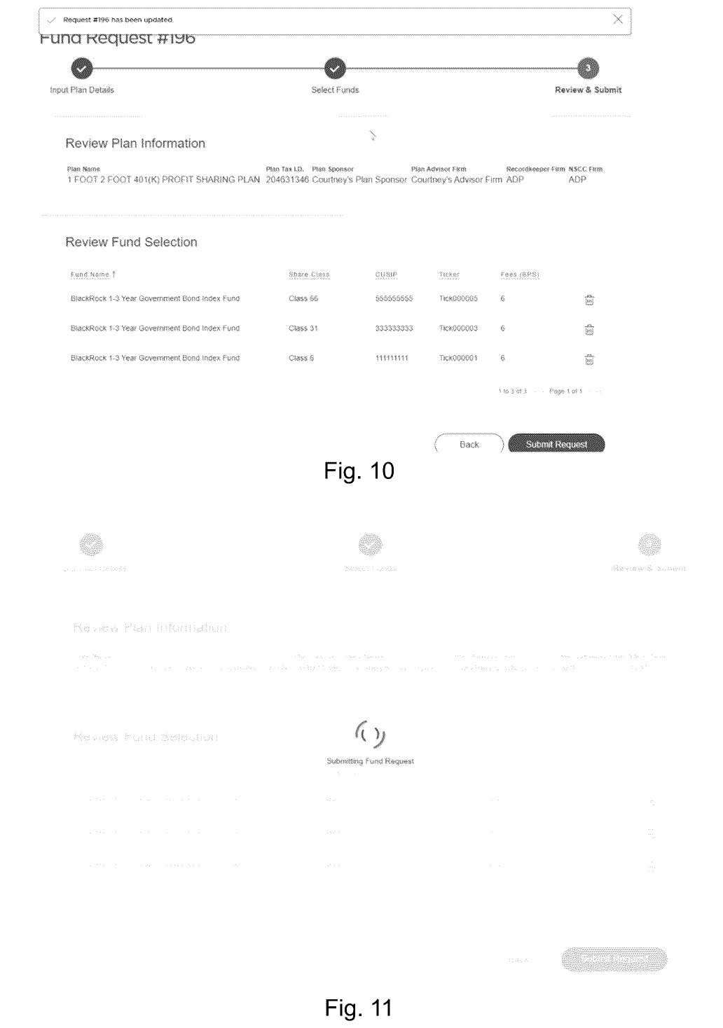

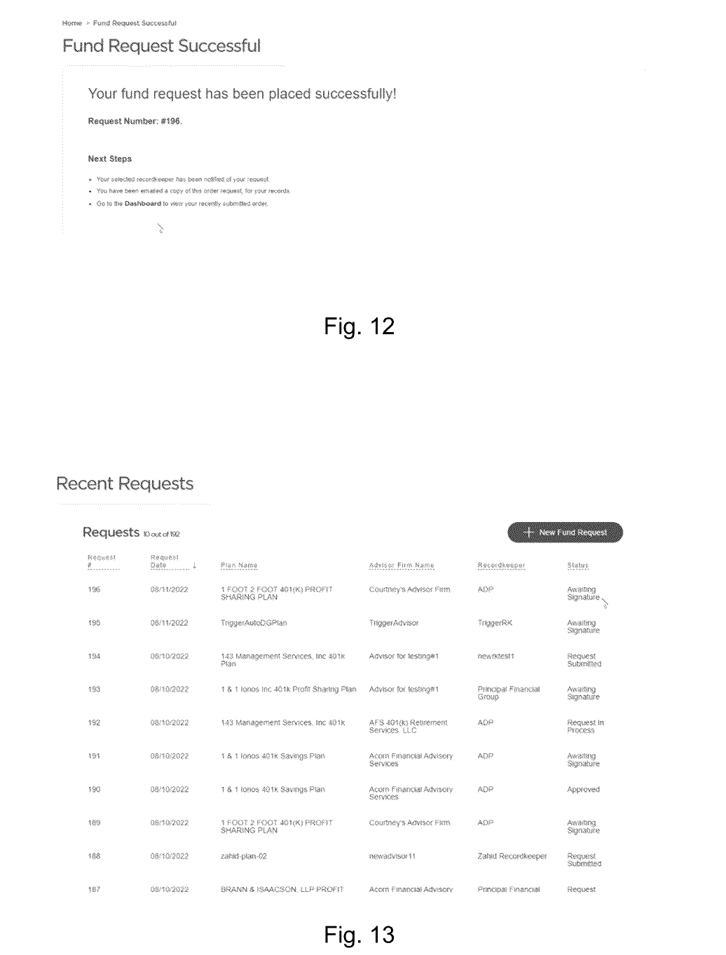

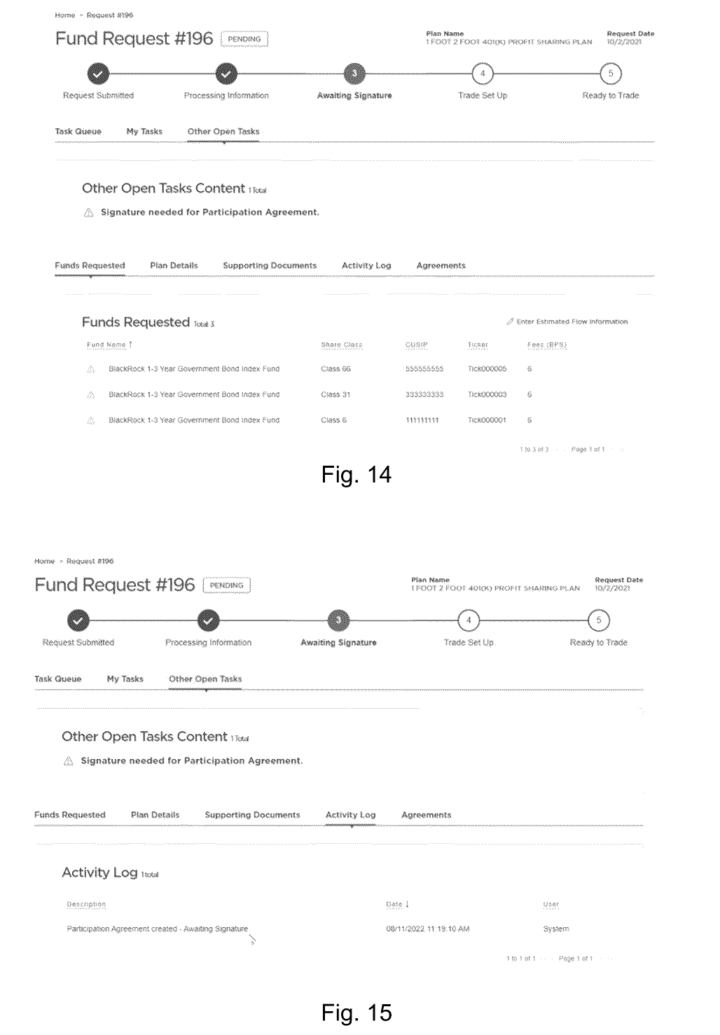

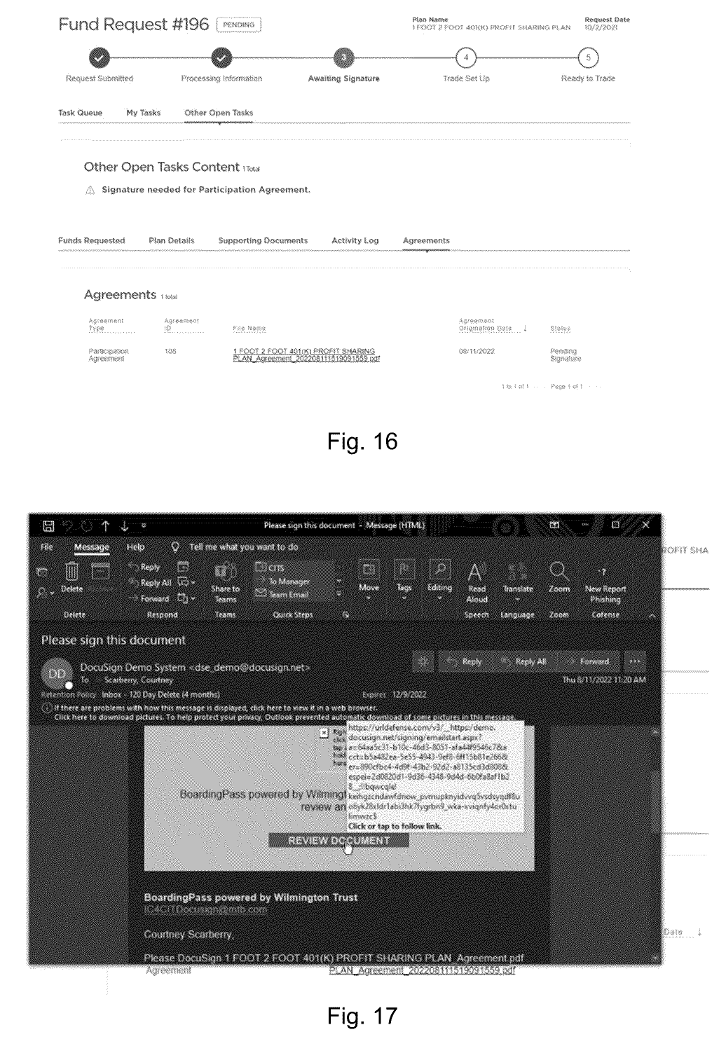

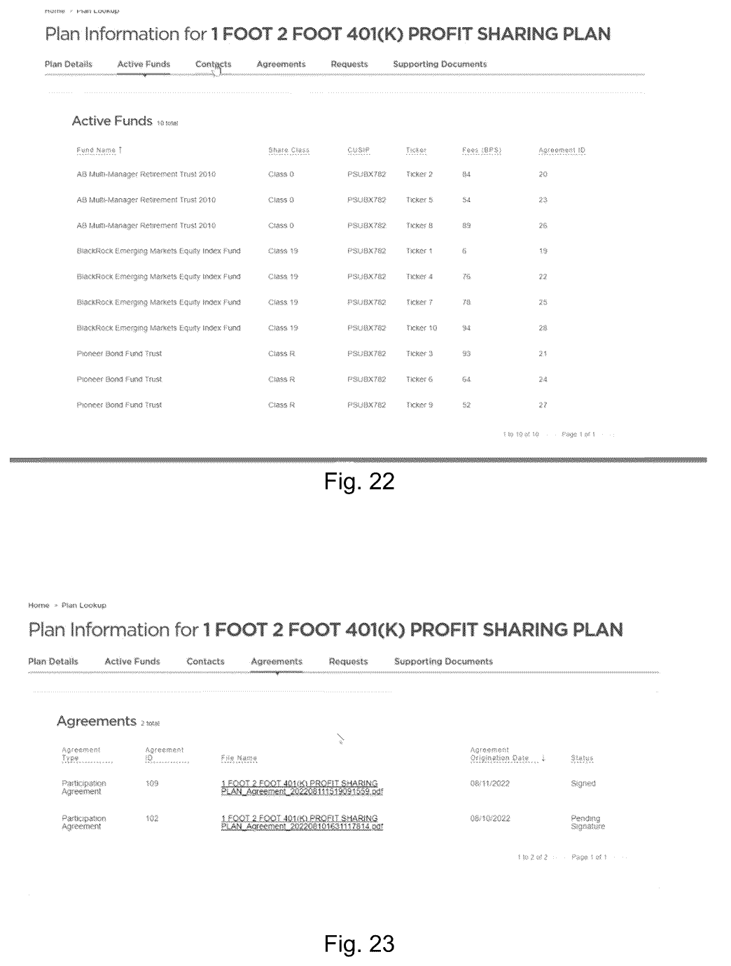

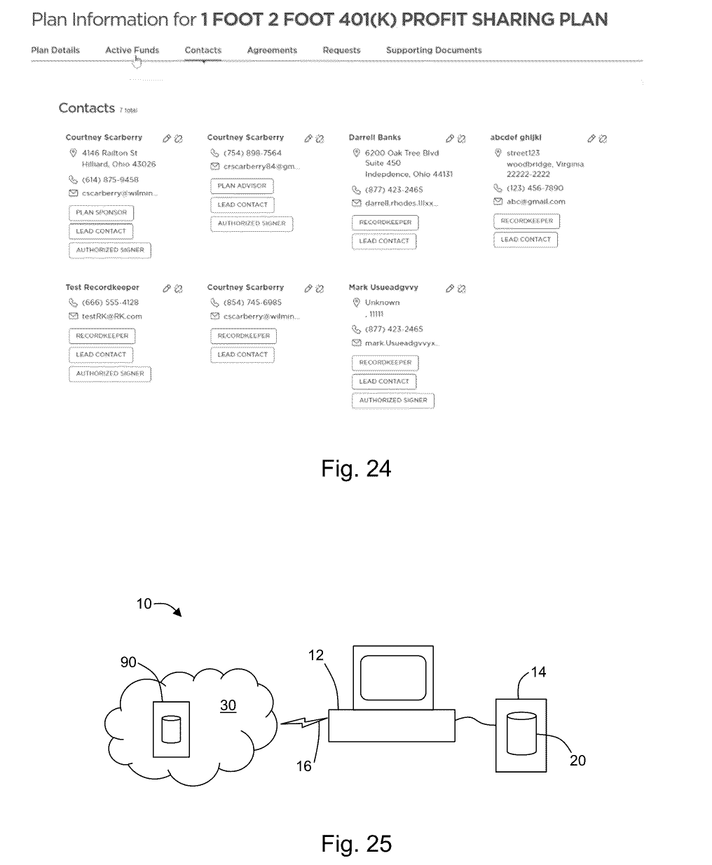

An example of an interface for some embodiments of the present systems and methods is shown in FIGS. 1 through 15 and 20 through 23. FIGS. 1 through 15 depict the interface as the present system gathers the necessary data and creates a customized agreement. FIGS. 16 through 19 depict the receipt of an email including a customized agreement and a hyperlink to electronically execute the same, as well as an example of the electronic signature process.

The foregoing system and method described herein minimize the burden and impact of the process of creating and establishing plans and participation agreements related thereto. Due in part to efficiencies obtained from the novel systems and methods, the time to establish a plan can be shortened from several days to several hours.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof

What is claimed is:

1. A computer-based method for enrolling an eligible retirement plan or other eligible entity into a collective investment trust (CIT), comprising:
receiving an electronic enrollment request for a plan, the enrollment request comprising enrollment data, wherein the enrollment data includes a plan identifier and an advisor identifier;
transmitting an electronic eligibility request to a DOL Form 5500 system, the electronic eligibility request including the plan identifier;
receiving a response from the DOL Form 5500 system confirming a eligible status of the plan;
retrieving, from a funds database, an electronic list of available funds based on the advisor identifier and displaying, on a user interface, the list of available funds as a selection list;
receiving a selection of one or more funds from the list of available funds;
determining if a participation agreement can be generated or if additional data is needed;
generating, automatically, the participation agreement for the plan based on the enrollment data and including the selection of one or more funds;
transmitting an electronic signature envelope to a signature provider, the electronic signature envelope comprising the participation agreement;
receiving an electronically-signed participation agreement from the signature provider; and
identifying the plan as ready to trade.

2. The method of claim 1, wherein the plan identifier is a tax ID.

3. The method of claim 1, wherein the step of determining if a participation agreement can be generated or if additional data is needed comprises:
confirming record keeper contact data is recorded;
confirming transfer agent contact data is recorded;
confirming trading platform data is recorded; and
confirming plan sponsor contact data is recorded.

4. The method of claim 1, further comprising:
updating an enrollment status field; and
generating an enrollment dashboard including the enrollment status field.

5. The method of claim 1, further comprising automatically transmitting a reminder to an enrollment contact if the electronically-signed participation agreement is not received within a predetermined period of time.

6. The method of claim 1, further comprising exporting transfer agent data from the enrollment data; and transmitting the transfer agent data to the transfer agent.

7. A system for enrolling an eligible retirement plan or other eligible entity into a collective investment trust (CIT), comprising:
a processor;
a storage medium in electronic communication with the processor;
a communication port in electronic communication with the processor; and
wherein the processor is programmed to:
receive an electronic enrollment request for a plan, the enrollment request comprising enrollment data, wherein the enrollment data includes a plan identifier and an advisor identifier;
transmit an electronic eligibility request to a DOL Form 5500 system, the electronic eligibility request including the plan identifier;
receive a response from the DOL Form 5500 system confirming a eligible status of the plan;
retrieve, from a funds database, an electronic list of available funds based on the advisor identifier and displaying, on a user interface, the list of available funds as a selection list;
receive a selection of one or more funds from the list of available funds;
determine if a participation agreement can be generated or if additional data is needed;
generate, automatically, the participation agreement for the plan based on the enrollment data and including the selection of one or more funds;
transmit, an electronic signature envelope to a signature provider, the electronic signature envelope comprising the participation agreement;
receive an electronically-signed participation agreement from the signature provider; and
identify the plan as ready to trade.

8. The system of claim 7, wherein the DOL Form 5500 system is an independent computer accessible by way of the communication port.

9. The system of claim 7, wherein the DOL Form 5500 system comprises a database stored on the storage medium.

10. The system of claim 7, wherein the processor determines if a participation agreement can be generated or if additional data is needed by:
confirming record keeper contact data is recorded;
confirming transfer agent contact data is recorded;
confirming trading platform data is recorded; and
confirming plan sponsor contact data is recorded.

11. The system of claim 7, wherein the processor is further programmed to:
update an enrollment status field; and
generate an enrollment dashboard including the enrollment status field.

12. The system of claim 7, wherein the processor is further programmed to transmit a reminder to an enrollment contact if the electronically-signed participation agreement is not received within a predetermined period of time.

13. The system of claim 7, wherein the processor is further programmed to export transfer agent data from the enrollment data; and transmitting the transfer agent data to the transfer agent.

14. A non-transitory computer-readable medium having stored thereon a program for instructing a processor to:
receive an electronic enrollment request for a plan, the enrollment request comprising enrollment data, wherein the enrollment data includes a plan identifier and an advisor identifier;
transmit an electronic eligibility request to a DOL Form 5500 system, the electronic eligibility request including the plan identifier;
receive a response from the DOL Form 5500 system confirming a eligible status of the plan;
retrieve, from a funds database, an electronic list of available funds based on the advisor identifier and displaying, on a user interface, the list of available funds as a selection list;
receive a selection of one or more funds from the list of available funds;
determine if a participation agreement can be generated or if additional data is needed;
generate, automatically, the participation agreement for the plan based on the enrollment data and including the selection of one or more funds;
transmit, an electronic signature envelope to a signature provider, the electronic signature envelope comprising the participation agreement;
receive an electronically-signed participation agreement from the signature provider; and
identify the plan as ready to trade.

15. The non-transitory computer-readable medium of claim 14, further comprising instructions to determine if a participation agreement can be generated or if additional data is needed by:
confirming record keeper contact data is recorded;
confirming transfer agent contact data is recorded;
confirming trading platform data is recorded; and
confirming plan sponsor contact data is recorded.

16. The non-transitory computer-readable medium of claim 14, further comprising instructions to update an enrollment status field; and
generate an enrollment dashboard including the enrollment status field.

17. The non-transitory computer-readable medium of claim 14, further comprising instructions to transmit a reminder to an enrollment contact if the electronically-signed participation agreement is not received within a predetermined period of time.

18. The non-transitory computer-readable medium of claim 14, further comprising instructions to export transfer agent data from the enrollment data; and transmitting the transfer agent data to the transfer agent.
